(19) United States
(12) Patent Application Publication
(10) Pub. No.: US 2005/0197861 A1
(43) Pub. Date: Sep. 8, 2005

(54) Examination management system and examination management method

(75) Inventors: Shinichi Omori, Tokyo (JP); Ryoichi Hosoya, Ichikawa (JP); Hiroyuki Araki, Tokyo (JP); Hideki Yasuda, Tokyo (JP); Nobuaki Matsubara, Saitama (JP); Masafumi Kobayashi, Sagamihara (JP); Kazuyuki Inokihara, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, TOKYO (JP)

(21) Appl. No.: 10/992,420

(22) Filed: Nov. 18, 2004

(30) Foreign Application Priority Data
Dec. 2, 2003 (JP) 2003-402464

(51) Int. Cl. G06F 17/60

(52) U.S. Cl. 705/2; 434/232

(57) ABSTRACT

An examination management system of the present invention comprises implemented information inputting means for inputting implemented information related to a content of implementation of medical conduct in which the conduct is implemented regarding the examination, implemented information storing means for storing therein the implemented information input by the implemented information inputting means, implemented information obtaining means for obtaining, from the implemented information storing means, implemented information corresponding to a content of implementation which is scheduled to be implemented using as a key a content of implementation of medical conduct which is scheduled to be currently implemented, and implemented information displaying means for displaying the implemented information obtained by the implemented information obtaining means.

### CROSS REFERENCE TO RELATED APPLICATIONS

This application claims benefit of Japanese Application No. 2003-402464, filed Dec. 2, 2003, the contents of which are incorporated by this reference.

### BACKGROUND OF THE INVENTION

1. Field of the Invention

The present invention relates to an examination management system and an examination management method for managing an examination device such as an electronic endoscope device or the like.
Description of the Related Art

Conventionally, there is a system in which information along a workflow of an endoscope examination can be input and referred to. In this conventional system, implementation information of an examination can be input and the input implementation information can be utilized for an account transaction. (See Japanese Patent Application Publication No. 2002-73615, for example)

Also, in the above conventional system, when inputting a report, a characteristic image selected out of recorded images can be attached to report information as a representative image indicating a result of an examination (i.e. the characteristic image is displayed simultaneously with the report information on a “Report inputting” window). Further, the position of photography can be separately input on the schema diagram in order to indicate on which organ (site) the photography was conducted.

### SUMMARY OF THE INVENTION

According to an aspect of the present invention, an examination management system of the present invention comprises an implemented information inputting unit for inputting implemented information related to a content of implementation of medical conduct which is implemented regarding the examination, an implemented information storing unit for storing therein implemented information input by the implemented information inputting unit, an implemented information obtaining unit for obtaining, from the implemented information storing unit, implemented information corresponding to a content of implementation which is scheduled to be implemented using as a key a content of implementation of medical conduct which is scheduled to be currently implemented, and an implemented information displaying unit for displaying the implemented information obtained by the implemented information obtaining unit.

### BRIEF DESCRIPTION OF THE DRAWINGS

The present invention will be more apparent from the following detailed description when the accompanying drawings are referenced.

FIG. 1 is a block diagram showing a configuration of an endoscope examination management system according to a first embodiment of the present invention;

FIG. 2 shows a software configuration of the endoscope examination management system of FIG. 1;

FIG. 3 shows a configuration of tables and master files managed by a database in a server of FIG. 1

FIG. 4 shows an “Examination transaction” main window which is opened in the endoscope examination management system of FIG. 1;

FIG. 5 is a flowchart showing a flow of examination by the endoscope examination management system of FIG. 1;

FIG. 6 shows a “Suspension of examination” window opened in the endoscope examination management system of FIG. 1;

FIG. 7 shows a “Preprocedure inputting” window opened in the endoscope examination management system of FIG. 1;

FIG. 8 shows a “Modifying” window opened in the endoscope examination management system of FIG. 1;

FIG. 9 shows a “Past data displaying” window 2001 opened by pressing a “Refer to past data” button 2000;

FIG. 10 shows a “Photography” window opened in the endoscope examination management system of FIG. 1;

FIG. 11 shows a “Procedure selecting” window;

FIG. 12 shows a “Past data displaying” window;

FIG. 13 shows an “Implementation inputting” window opened in the endoscope examination management system of FIG. 1;

FIG. 14 shows a “Report inputting” window opened in the endoscope examination management system of FIG. 1;

FIG. 15 shows a first “Term” window opened in the endoscope examination management system of FIG. 1;

FIG. 16 shows a second “Term” window opened in the endoscope examination management system of FIG. 1;

FIG. 17 shows an “Attribute inputting” window;

FIG. 18 shows a “Comment” menu opened in the endoscope examination management system of FIG. 1;

FIG. 19 shows an example in case that a “Preprocedure” 2002 is selected as an option on a “Comment” menu 168;

FIG. 20 is a block diagram showing a configuration of the endoscope examination management system according to a second embodiment of the present invention;

FIG. 21 shows a software configuration of the endoscope examination management system of FIG. 20;

FIG. 22 explains an input transaction of data in the first embodiment; and

FIG. 23 explains an input transaction of data in the second embodiment.

### DESCRIPTION OF THE PREFERRED EMBODIMENTS

Hereinafter, preferred embodiments of the present invention will be described with reference to the drawings.

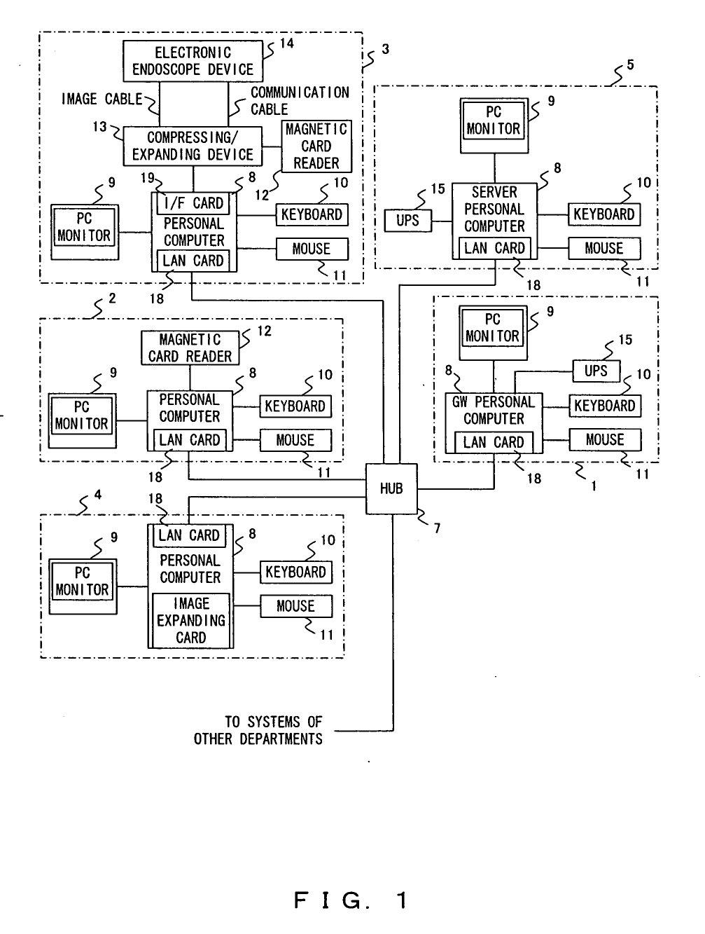

FIG. 1 shows a hardware configuration of an endoscope examination management system according to a first embodiment.

In FIG. 1, the endoscope examination management system of the present invention mainly comprises a GW 1 (gateway) for exchanging data with other departments in a hospital, a reception terminal 2 for receiving an application for an examination, an input/examination terminal 3 for examining, a search terminal 4 for displaying and inputting an image and various kinds of information, and a server 5 for recording data. The above respective devices are connected to one another via a network (LAN) distributed by a HUB 7.

Also, each device includes, as basic components, a personal computer (PC) 8, a PC monitor 9, a keyboard 10, and a mouse 11 and is connected to the network via a LAN card 18 included in the personal computer 8.

The GW 1 comprises, in addition to the above basic components, a UPS (uninterrupted power supply) 15 in order to meet a sudden power failure.

The reception terminal 2 comprises a magnetic card reader 12 in addition to the above basic components. The reception terminal 2 is installed at a reception desk or the like in a department in order to be used for a reception transaction for an examination.

The input/examination terminal 3 comprises, in addition to the above basic components, the magnetic card reader 12, a compressing/expanding device 13. The compressing/expanding device 13 is connected to an electronic endoscope device 14 via an image cable and a communication cable. Also, the compressing/expanding device 13 is connected to the personal computer 8 via an I/F card 19 included in the personal computer 8. The input/examination terminal 3 is installed in an examination room in order to be used when the examination is conducted.

The search terminal 4 comprises only the above basic components and is installed in a conference room or the like in order to be used for conference transaction.

The server 5 comprises, in addition to the above basic components, the UPS 15 in order to meet a sudden power failure.

Also, the electronic endoscope device 14 comprises an electronic endoscope and a processor device for processing and outputting image signal, which configuration is the same with that of a well known electronic endoscope device, so that details thereof are not shown in drawings. The electronic endoscope comprises an elongated insertion unit to be inserted into a body and an operating unit attached to a distal end of the insertion unit. And the operation unit is provided with a release switch for issuing a releasing order so that an image can be recorded by pressing a button of the release switch.

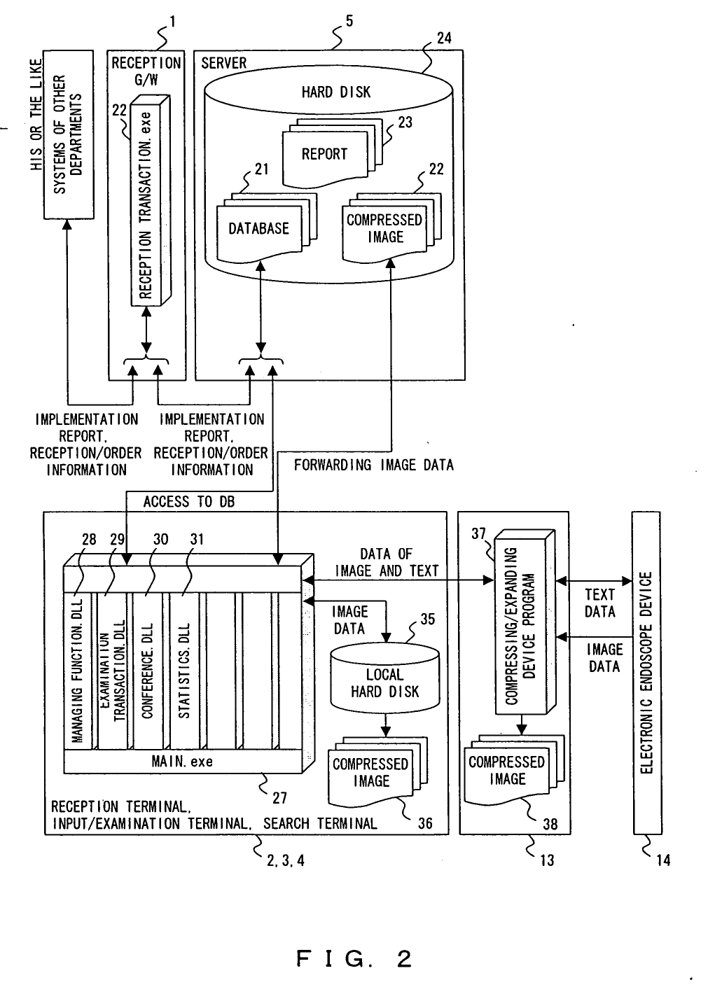

FIG. 2 shows a software configuration of the endoscope examination management system of the present invention.

In FIG. 2, in a hard disk of each device, various application software and databases or the like are installed in order to be operated thereon.

On the GW 1, a GW application software 20 is operated.

On a hard disk 24 of the server 5, a database 21 is operated and a compressed image 22 photographed by the input/examination terminal 3 and report information 23 of examination is recorded and stored.

The reception terminal 2, the input/examination terminal 3 and the search terminal 4 employ same software configurations with one another and main application software 27 are operated on the above three devices. The main application software 27 mainly comprises an examination transaction DLL (Dynamic Link Library) 29, a conference DLL 30, a statistics/history DLL 31 and a managing function DLL 28. Also, a compressed image 36 can be temporally stored in a hard disk 35.

As described above, the reception terminal 2, the input/examination terminal 3 and the search terminal 4 employ same software configurations with one another. Therefore, the differences among the three devices are the purposes of use which change depending on where the devices are installed.

However, only the input/examination terminal 3 is different from the others in that the compressing/expanding device 13 for recording/compressing of image is connected to the terminal 3 so that an image can be photographed upon the examination. On the compressing/expanding device 13, a compressing/expanding device program 37 is operated and a compressed image 38 can be temporally stored in a memory of the compressing/expanding device 13. Also, the compressing/expanding device 13 is connected to the electronic endoscope device 14.

Next, operations of the endoscope examination management system of the present invention will be explained.

Firstly, kinds of information regarding an examination are explained, which information is also to be managed by the management system of the present invention.

The information to be managed by the managing system of the present invention mainly comprises the following four kinds of information.

1) Patient Information

Patient Basic Information

The patient basic information is for identifying one patient, which information comprises “patient ID”, “full name”, “birth date”, “sex” and the like. The “patient ID” is a number uniquely corresponding to a patient so that each patient can be identified.

Patient Profile Information

The patient profile information is for indicating characteristics and a condition of each patient, which information comprises “blood type”, “height/weight”, “allergy”, “disability”, “infection”, “disease/notandum”, “result of sample examination” and “prior medication information”.

2) Examination Order Information

The examination order information regards an order for an examination in case that an examination order is issued to an endoscope department by other departments. The examination order information comprises order key information “order number”, “date of issue” and the like), order source information “name of department issuing order”, “name of doctor issuing order”, “date of order” and the like), order information “name of disease to be examined”, “purpose of examination”, “type of examination”, “item of examination”, “site to be examined”, “comment”, “schema image” and the like), examination reservation information “date of examination”, “time of implementation” and the like) and the like. And the above information is transmitted to each system of departments from HIS (hospital information system). The order key information is for uniquely identifying one examination order.

3) Examination Implementation Information (Account Information)

Examination implementation information regards a content of implementation of examination, which information comprises “date and time of implementation”, “implementing person”, “place of implementation”, “technique”, “medicine”, “instrument” and the like. Information such as implemented “technique”, or used “medicine”, “instrument” and the like is used for accounting. This information is transmitted to HIS from an endoscope department system so that transaction is conducted in an accounting system of the HIS.

4) Examination Result Information (Report Information)

The examination result information regards an examination result, which information becomes a report responding to an examination order and comprises “date of report”, “reporting person”, “diagnosis”, “remarks”, “procedure”, “comment”, “notice/instruction after examination”, “image”, “schema image” and the like. The above information can be referred to in a medical image filing system provided in an endoscope department and also, can be referred to in systems of other departments by being transmitted from the present system to HIS. Therefore, the examination result (report) can be referred to in a department which issued an examination order.

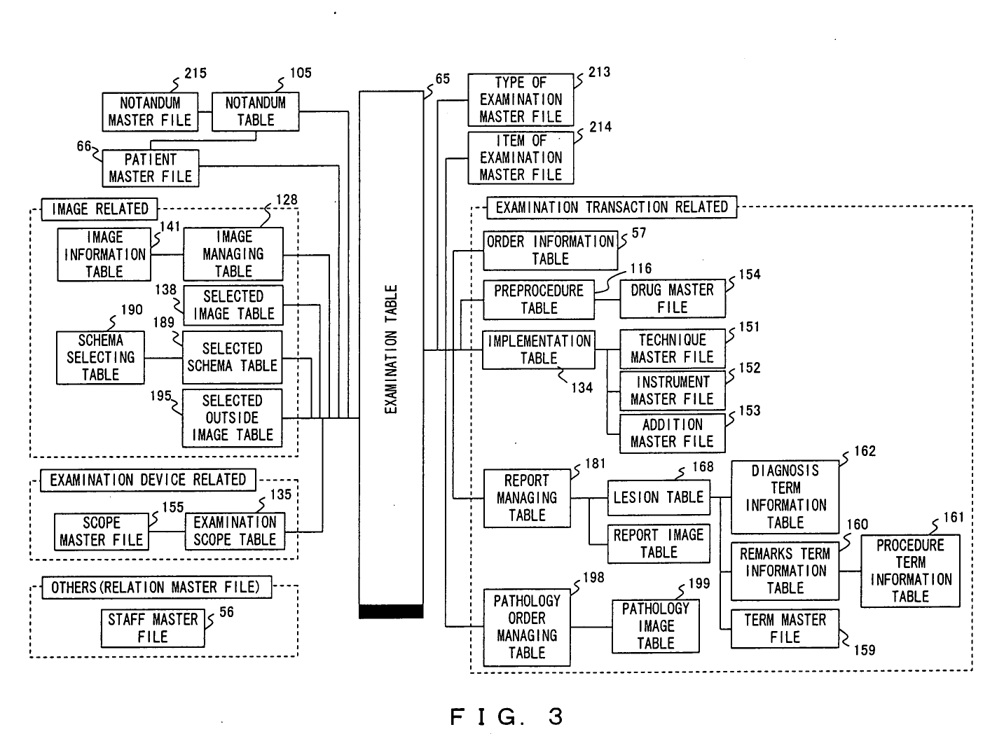

FIG. 3 shows a configuration of tables/master files managed by a database 21 in the server 5.

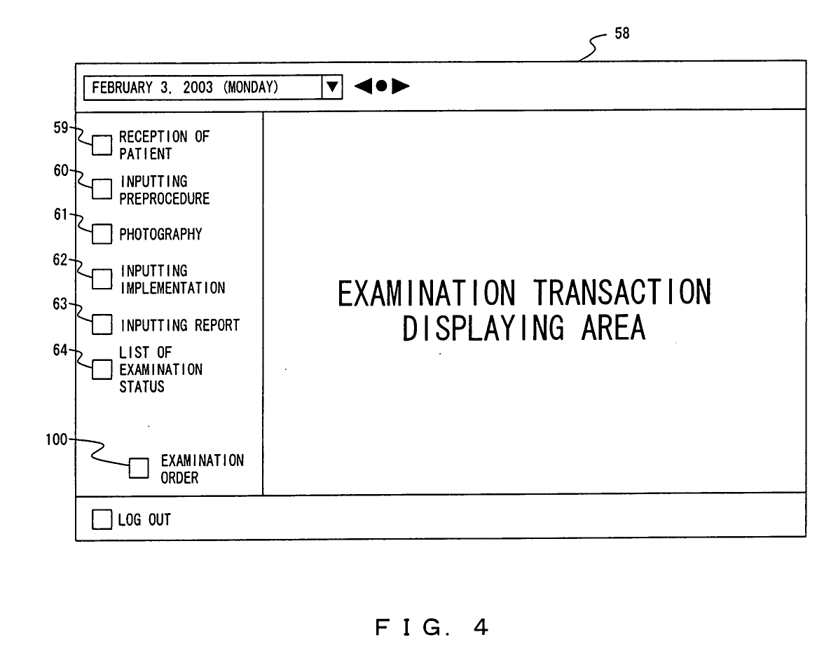

FIG. 4 shows an “Examination transaction” main window 58 which has been opened by clicking an “Examination transaction” icon 52.

On the left portion of the window, icons corresponding to respective transactions are arranged so that respective windows are opened by clicking the icons. The icons include “reception of patient” icon 59, “Inputting preprocedure” icon 60, “photography” icon 61, “Inputting implementation” icon 62, “Inputting report” icon 63, “list of examination status” icon 64, and “examination order” button icon 100.

Next, operations will be explained by following a flow of examination.

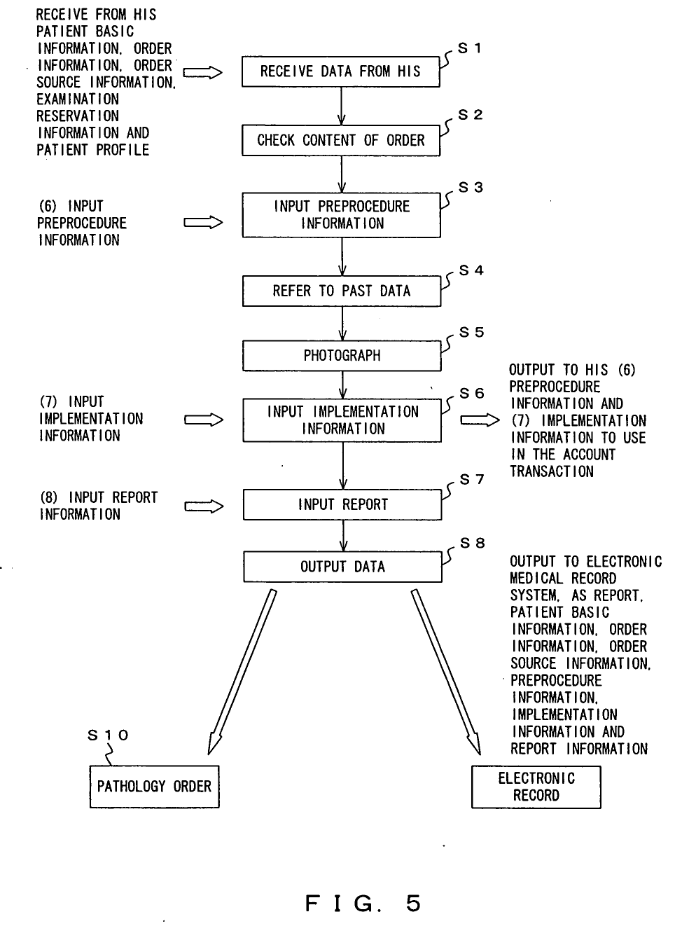

FIG. 5 is a flowchart showing a flow of examination.

<Step 1 (S1)>

When an examination order is issued from another department to the endoscope department, patient information (patient basic information and patient profile information) and examination order information (order information, order source information and examination reservation information) is transmitted from the HIS so that the system of the present invention receives the information. Specifically, a GW application software 20 on the GW 1 receives information from the HIS so that the received information is registered in an examination table 65, a patient master file 66 and an order information table 57 in the database 21.

When profile information of the patient is included to the received information, the profile information is associated with the patient master file and is registered on a notandum table 105.

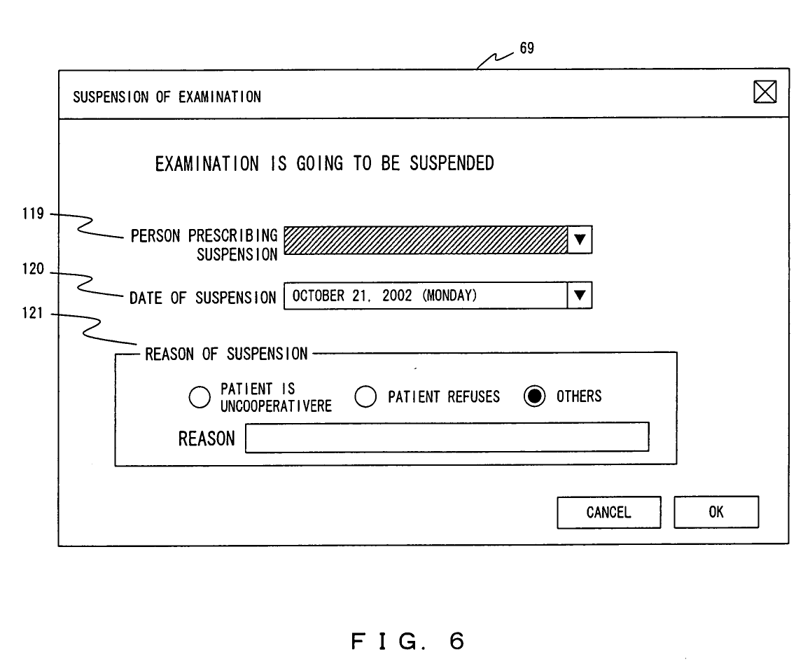

FIG. 6 shows a “Suspension of examination” window 69.

When it is desired that an examination is suspended, the “Suspension of examination” window is opened. On the “Suspension of examination” window, person prescribing suspension 119, date of suspension 120 and reason of suspension 121 can be input, which are respectively registered in an examination table in the database 21. Also, status of examination on the examination table is updated to “Suspended” status.

Upon suspension of an examination, a control is conducted under the following conditions.

(1) The examination can be suspended only before the photography is started

(2) The suspension of examination causes different processing from that of cancellation of an examination order, i.e. the suspension of examination does not mean a cancellation of an examination order (the examination order in the list of examination is not deleted)

(3) The modification of examination order or the cancellation thereof can not be accepted from the HIS after the reception processing or after a closing time for application for examination (The suspension of examination can be accepted)

The above conditions are prepared so that a gap of understanding of information among ordered doctors for examination and examination staffs does not occur.

Also, the above conditions are prepared so that such a situation or the like are avoided that an examination order is modified after the examination is started or that the cancellation of the examination order is not informed.

<Step 2 (S2)>

According to the system of the present invention, reservations are managed based on received examination reservation information so that scheduled examinations can be displayed in correspondence with each status of the examination in a listed manner.

The reception terminal 2 and the input/examination terminal 3 include the same software as each other so that both of the reception terminal 2 and the input/examination 3 terminal (or also a search terminal 4) can refer to the above list.

<Step 3 (S3)>

Next, a window which is used upon conducting the preprocedures such as an anesthetization or the like to a patient before the examination, is explained.

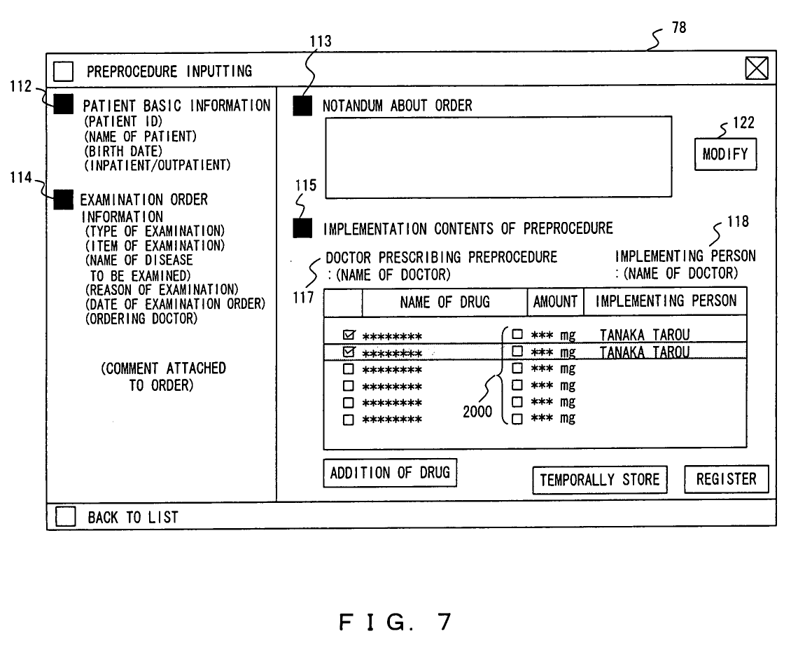

FIG. 7 shows a “Preprocedure inputting” window 78.

Also this “Preprocedure inputting” window 78 can be referred to by both of the reception terminal 2 and the input/examination terminal 3 (or also a search terminal 4).

The “Preprocedure inputting” window 78 mainly comprises a patient basic information displaying area 112, an examination order information displaying area 114, a notandum displaying area 113 for displaying allergy information, disease/notandum or the like, and a preprocedure implementation content displaying area 115 for inputting the preprocedure information.

On the “Preprocedure inputting” window 78, each information regarding the preprocedures obtained from a preprocedure table 116 in the database 21 is displayed and also, the items (contents of medication) implemented as the preprocedures can be input additionally. By obtaining and displaying, on a window, selection options of a drug master file 154 in the database 21 and selecting one of the selection options, the selected drug information can be registered on the preprocedure table 116. The input information on this window is later obtained from the preprocedure table 116 in the database 21 and transmitted to the HIS together with the examination implementation information in order to be utilized for accounting.

When a doctor prescribing preprocedure 117 and an implementing person 118 are input so that the confirmation/input thereof is completed, the information can be registered in the database 21 by pressing the “Register” button 65. Also, the examination status managed on the examination table 65 is updated to the “Preprocedure implemented” status.

Also, the received notandum (patient profile information) can be modified based on additionally found notandum (profile information) of patient upon the implementation of the preprocedure or the like.

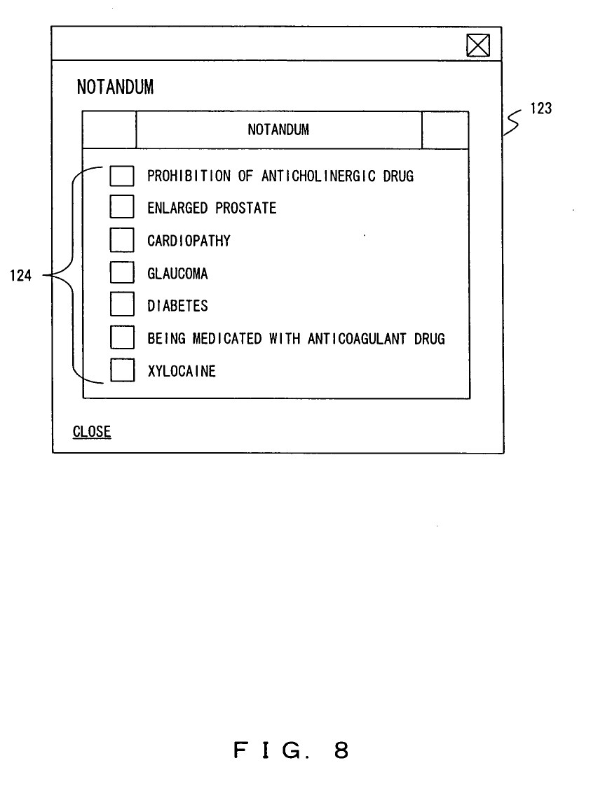

FIG. 8 shows a “Modifying” window 123 for notandum (patient profile information).

When a “Modify” button 122 arranged on an upper portion of the “Preprocedure inputting” window 78 is pressed, the “Modifying” window 123 for notandum (patient profile information) as shown in FIG. 8 is opened.

By checking checkboxes 124 for notandum arranged on the “Preprocedure inputting” window 78 into ON state or by canceling these checkboxes into OFF state, the information can be modified and registered. The modified information is registered on a notandum table 105 in the data base 21 as the latest information. However, when canceling the check on the checkboxes into OFF state, the user ID and the password are required so that they are verified with the staff master file 56 and recorded, which requirement of ID and password is not performed for checking the checkbox into ON state. This is because, in order to avoid the situation that an item of notandum which has to be actually cared for is not cared for, more caution is needed for a modification of information where an item of notandum is deleted, and less caution is needed for a modification where the item of notandum is added.

<Step 4 (S4)>

Further, on the “Preprocedure inputting” window 78, upon the implementation of preprocedure, the past data can be referred to. For example, when determining the amount of anesthetic, the window can be used for the determination of the suitable amount based on the past data. By pressing a “Refer to past data” button 2000, the past data can be displayed.

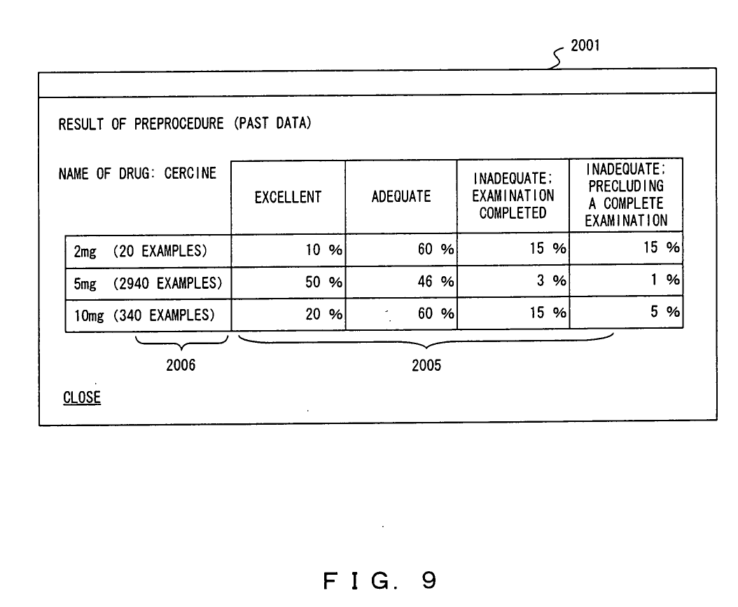

FIG. 9 shows a “Past data displaying” window 2001 opened by pressing the “Refer to past data” button 2000.

On the “Past data displaying” window 2001, past implementation data obtained from the database 21 is displayed. The displayed contents are “percentages of results (qualities) of preprocedures for each used amount” 2005 and “population parameter of data” 2006.

In FIG. 9, the results (qualities) of preprocedures are ranked into four ranks, i.e. (1) Excellent, (2) Adequate, (3) Inadequate; examination completed, (4) Inadequate; precluding a complete examination.

The above results of preprocedures are based on data input on a “Report inputting” window which will be described later. And the above four ranks of (1) Excellent to (4) Inadequate are recorded on a lesion table 168 in the database 21.

On the other hand, the used drug and the used amount thereof upon the preprocedure are recorded on the preprocedure table 116. Therefore, by searching the preprocedure table, the examination using the input drug and the used amount thereof can be identified. And by obtaining the result of the preprocedure which was input upon the report input of the identified examination from the lesion table 168, all the necessary data is prepared. Thereby, the “Past data displaying” window 2001 can be displayed.

Also, the above percentages can be displayed for each of the following parameters instead of the results (qualities) of preprocedures.

Sex (In order to determine whether or not the effects of the anesthesia are influenced by the sex)

Age (In order to determine whether or not the effects of the anesthesia are influenced by the age)

Age (In order to determine whether or not the effects of the anesthesia are influenced by the height)

Height (In order to determine whether or not the effects of the anesthesia are influenced by the weight)

Number of anesthetizations experienced (In order to find the possibility that the effect of anesthetic is reduced because of many numbers of anesthetization experienced, or the like

Type of examination (In order to determine whether or not larger amount of anesthetic is required based on the time period of the examination)

Also, the above processing of step 4 can be executed after the step 2.

<Step 5 (S5)>

Next, operations upon the photography as in step 5 in FIG. 5 will be explained.

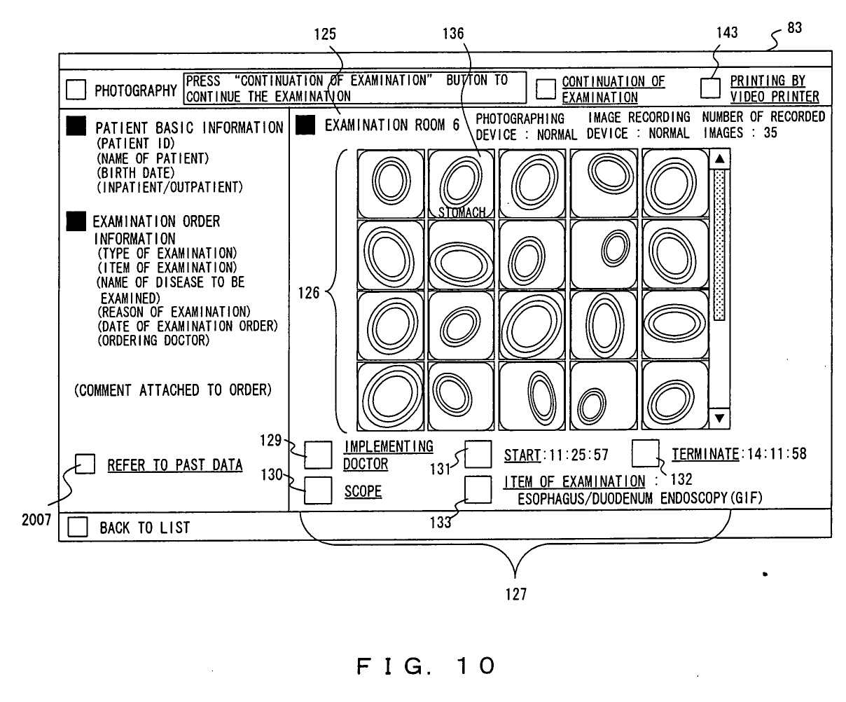

FIG. 10 shows a “Photography” window 83.

The “Photography” window 83 displays, in addition to the patient information and the examination order information displayed on the left portion of the window, examination room/examination device information 125, photographed image information 126, and examination implementation information inputting area 127 are displayed on a right portion of the window.

When the “Photography” window 83 is displayed, patient information is transmitted to the input/examination terminal 3 installed in the examination room so that the patient information is displayed on the electronic endoscope device 14 connected to the terminal 3.

Further, because the magnetic card reader 12 is connected to the input/examination terminal 3, it is also possible that a magnetic card of a patient is inserted to the card reader 12 for inputting the patient basic information and the data corresponding to the input patient basic information is selected there by performing an automatic assigning (drawing) control to the input/examination terminal 3 itself.

When the transmission of the examination device patient information is completed as above, the examination gets ready to be implemented so that photography can be started by pressing a “Photography” button 68.

On a photographed image displaying area 126, reduced images photographed for each releasing operation on the electronic endoscope device 14 are sequentially arranged.

When a releasing operation is conducted, the photographed image is firstly taken into the compressing/expanding device 13 so that the image is compressed. The compressed image is temporally recorded in a memory in the compressing/expanding device 13 together with the patient basic information as well as forwarded to the personal computer 8 of the input/examination terminal 3. Even if the transmission of the images fails due to a break of cables or the like, the photography can be continued without a suspension because the photographed images can be temporally recorded in the memory of the compressing/expanding device 13.

Also, the images forwarded to the personal computer 8 of the input/examination terminal 3 are temporally recorded in the hard disk 35, and also, is forwarded to the hard disk 24 in the server 5. Also upon this operation, even if the transmission of the images fails due to a break of cables or the like, the photography does not have to be suspended because the image data is recorded in the hard disk 35 of the input/examination terminal 3.

By expanding the compressed image 36 recorded in the hard disk 35, above described reduced images 71 are displayed.

And, when a “Terminate examination” button on the electronic endoscope device 14 is pressed, the photography operation is terminated so that the status information of examination managed on the examination management table 65 in the database 21 is updated to the “Terminated” status.

The control of the above photography operation in the examination is controlled by the examination transaction DLL 29 of the main application software 27 on the input/examination terminal 3.

As for the photographed image, the pointer information thereof is registered on an image managing table 128, being associated with the data of examination on the examination table 65, which pointer information identifies the location of the storage of the image.

Also, on this window, the input of the following information of (1) to (5) are possible, in addition to the photography of image.

These information of (1) to (5) conventionally could not be input on the “Photography” window so that they had to be input on another window after the examination.

However, this information essentially should be input just at a time and place of the photography operation in view of the efficiency and the avoidance of mistakes. Therefore, in the present invention the input thereof is possible on the “Photography” window.

(1) Implementing Doctor

When an “Input implementing doctor” button 129 is pressed, a window for selection of the name of doctor who implemented the examination is opened. When a name of doctor is selected, the information of the name is registered on the implementation table 134 in the database 21. Because the examination maybe implemented by a plurality of doctors, a plurality of names of doctors can be selected.

(2) Used Scope

When an “Input scope” button 130 is pressed, a window for selection of the scope used for the examination is opened (the selection option is obtained from a scope master file 155 in the data base 21 in order to be displayed). When the used scope is selected, the information of the scope is registered on an examination scope table 135 in the database 21. The scopes may be exchanged during the examination, accordingly a plurality of the scopes can be registered.

(3) Start Time of Photography

The time at which the “Photography” window is opened is displayed beside a “start” button. When the “Start” button 13 is pressed, a window for input of start time of photography is opened and the start time can be modified. The start time of photography is registered on the examination table 65 in the database 21.

(4) End Time of Photography

When a “Terminate examination” button on the electronic endoscope device 14 is pressed, the end time of examination is displayed beside the “Terminate” button 132. Also, when the “Terminate” button 132 is pressed, a window for input of the end time of photography is opened so that the end time of photography can be modified. The end time of photography is registered on the examination table 65 in the database 21.

(5) Item of Examination

When an “Item of examination” button 133 is pressed, a window for selection/input of items of examination is opened. When items of examination are selected, the selected items are registered on the examination table 65 in the database 21.

There are cases that the items actually examined are different from the items of examination designated at a time of the examination order. Therefore, on the “Photography” window, the items of examination which have been actually implemented can be selected and registered, taking the above cases into consideration. (This is for a case that although only a screening was scheduled at a time of issue of an order, some procedure was actually implemented because a lesion was found during the screening, or the like)

Also, the above (3) Start time of photography and (4) End time of photography can be automatically registered for a case or the like that an examination is implemented by inputting a patient ID on the electronic endoscope device 14 without opening the “Photography” window.

The respective times are registered by controls following below.

<Start time of Photography>

Case 1: The time at which the “Photography” window is opened is registered

Case 2: If a more precise time is desired to be input, the “Start” button 131 is pressed in order to input the precise time after opening the “Photography” window

Case 3: If photography is implemented without opening the “Photography” window, the time at which the first image is recorded is registered

<End time of Photography>

Case 1: The time at which operation of termination of examination is conducted on the electronic endoscope device 14 or the time at which the power of observation device is turned off is registered

Case 2: If a more precise time, not based on the processing of Case 1, is desired to be input, the time is input by the “Terminate” button 132

Case 3: If photography is implemented without opening the “Photography” window, the end time is registered in the same manner as in the Case 1

Further, on the “Photography” window 83, past data can be referred to regarding the implementation of procedures during an examination. For example, when some procedure is implemented, the percentage of successfulness/unsuccessfulness of that procedure can be referred to based on the past implementation data. When a “Refer to past data” button 2007 is pressed, the past data can be displayed.

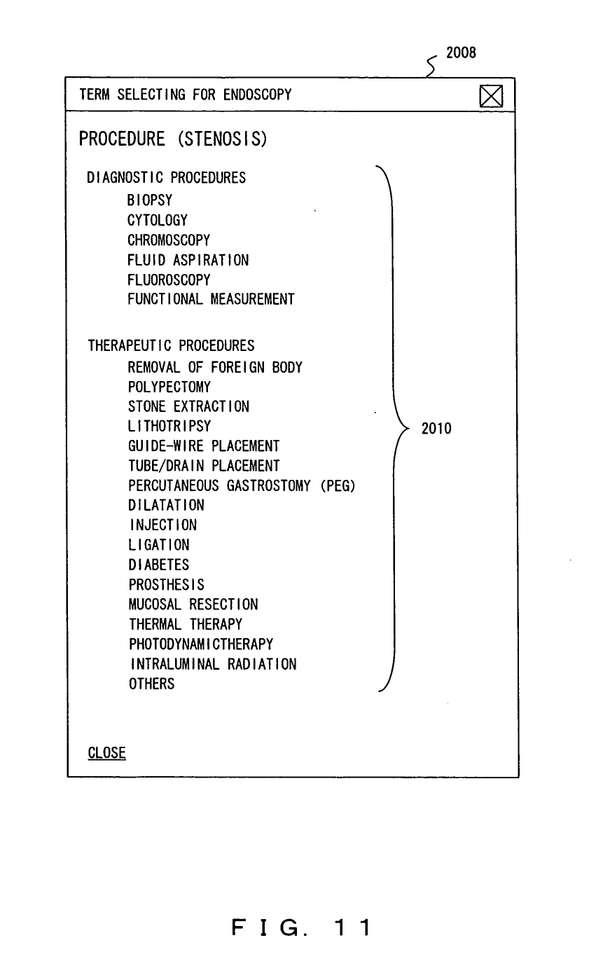

FIG. 11 shows a “Procedure selecting” window.

When the “Refer to past data” button 2007 is pressed, a “Procedure selecting” window 2008 is opened as shown in FIG. 11, so that procedure can be selected, about which the data is desired to be referred to.

The options 2010 of the “Procedure selecting” window 2008 can be displayed by obtaining the type of procedure stored in a term master file 159 in the database 21. This “Procedure selecting” window 2008 can be opened also upon the input of contents of procedure so that the system can be operated in a same manner.

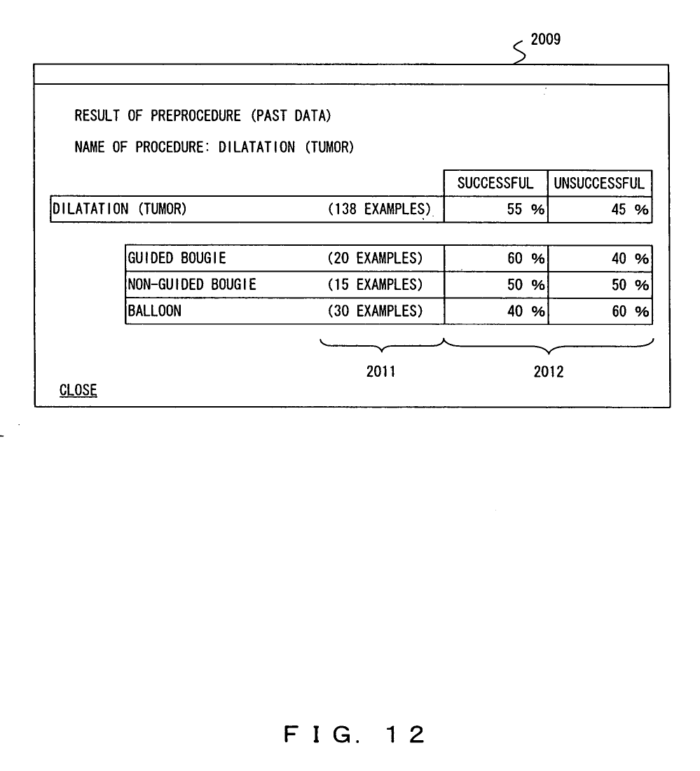

FIG. 12 shows a “Past data displaying” window.

When the options of procedure 2010 which is to be referred to on the “Procedure selecting” window 2008, a “Past data displaying” window 2009 of the procedure shown in FIG. 12 is opened.

The above past data of procedure is based on the procedure data input on a “Report inputting” window which will be described later and the result of successfulness or unsuccessfulness and the method used for the procedure are recorded on a procedure term information table 161 in the database 21. Therefore, by obtaining the past data from the procedure term information table 161 and counting the data, the “Past data displaying” window 2009 can be displayed.

Also, in the present embodiment, by pressing the “Refer to past data” button 2007 on the “Photography” window 83 and selecting types of procedure on the “Procedure selecting” window 2008, the past data of procedure can be referred to, however, the contents of the procedure which are going to be currently implemented can be automatically detected so that the selection labor of the type of procedure is saved. As for methods for detecting the types of procedure which is going to be currently implemented, the method is possible that the identifiers of instruments (tools used for procedure) which are going to be used are read (by the electronic tag, scanner and the like) and the kinds of the instruments are recognized in order to identify a type of procedure which is going to be currently implemented.

The type of procedure can be identified by having a configuration that the types of procedure that can use the instruments are registered in an instrument master file 152 in the database 21 for each of the instruments so that the instruments which are going to be currently used can be recognized (by an identifier such as RF-tag or the like).

Next, operations upon the input of implementation information of step 6 of FIG. 5 will be explained.

<Step 6 (S6)>

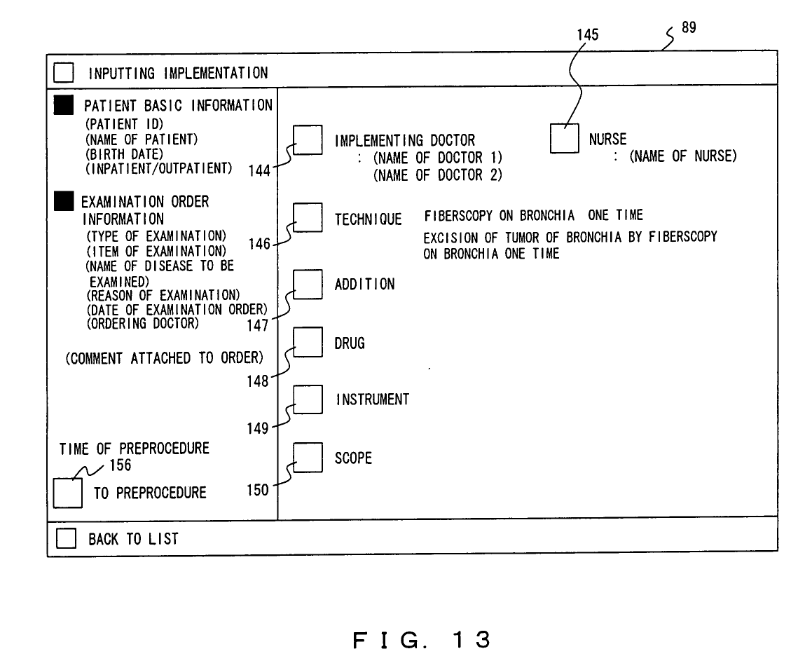

FIG. 13 shows an “Implementation inputting” window 89.

On the above “Implementation inputting” window, the contents of implementation of the examination (implementing doctor 144, nurse 145, technique 146, addition 147, drug 148, instrument 149 and scope 150) can be registered on the right portion of the window in addition to that the patient information and the examination order information can be displayed on the left portion of the window.

When a button 156 for inputting preprocedure is pressed, the “Preprocedure inputting” window 78 can be opened.

By pressing respective buttons of 144 to 150, respective windows for information input are opened so that the implementation information to be registered can be selected and input.

(1) Implementing Doctor

The selected implementing doctor information can be registered on the implementation table 134 by obtaining the selection options from the staff master file 56 in the database 21, displaying the selection options on the window, and by selecting the option.

However, when the implementing doctor information has already been registered on the “Photography” window 83, the registered information can be displayed at a time when the “Implementation inputting” window is opened. (Also, the modification and registration of the information is possible on the “Implementation inputting” window)

(2) Nurse

The selected nurse information can be registered on the implementation table 134 by obtaining the selection options from the staff master file 56 in the database 21, displaying the selection options on the window, and by selecting the option.

(3) Technique

The selected technique information can be registered on the implementation table 134 by obtaining the selection options from a technique master file 151 in the database 21, displaying the selection options on the window, and by selecting the option.

(4) Addition

The selected addition information can be registered on the implementation table 134 by obtaining the selection options from an addition master file 153 in the database 21, displaying the selection options on the window, and by selecting the option.

(5) Drug

The selected drug information can be registered on the implementation table 134 by obtaining the selection options from a drug master file 154 in the database 21, displaying the selection options on the window, and by selecting the option.

However, when the drug information has already been registered on the “Preprocedure inputting” window 78, the registered information can be displayed at a time when the “Implementation inputting” window is opened. (Also, the modification and registration of the information are not possible on the “Implementation inputting” window in order to distinguish the drug medicated upon the preprocedure and the drug medicated upon the implementation of examination)

(6) Instrument

The selected instrument information can be registered on the implementation table 134 by obtaining the selection options from an instrument master file 152 in the database 21, displaying the selection options on the window, and by selecting the option.

(7) Scope

The selected scope information can be registered on an examination scope table 135 by obtaining the selection options from a scope master file 155 in the database 21, displaying the selection options on the window, and by selecting the option.

However, when the scope information has already been registered on the “Photography” window 83, the registered information can be displayed at a time when the “Implementation inputting” window is opened. (Also, the modification and registration of the information are possible on the “Implementation inputting” window)

When the respective implementation information is selected, input and registered as above, the input of the implementation information is completed so that the examination status managed on the examination table 65 in the database 21 is updated to the “Implementation input completed” status.

Further, the input implementation information is transmitted to the HIS via a LAN together with the preprocedure information input on the “Preprocedure inputting” window 78 by the GW 1. In the HIS, it is

possible that an account transaction is conducted based on the above preprocedure information and the examination implementation information, and the calculation of the insurance claim points or the like is conducted.

However, upon the transmission of the above preprocedure information and the examination implementation information, the account transaction is conducted in the HIS, therefore, a case can occur that by the time when the change/modification of the preprocedure information or the examination implementation information is input, the account transaction is finished. Accordingly, when the information once registered is changed and input and the modified information is to be registered on the “Preprocedure” window 78 and the “Implementation inputting” window 89, a message indicating the possibility that the account transaction is finished is displayed.

Next, operations upon the input of report shown as in the step 7 of FIG. 5 will be explained.

<Step 7 (S7)>

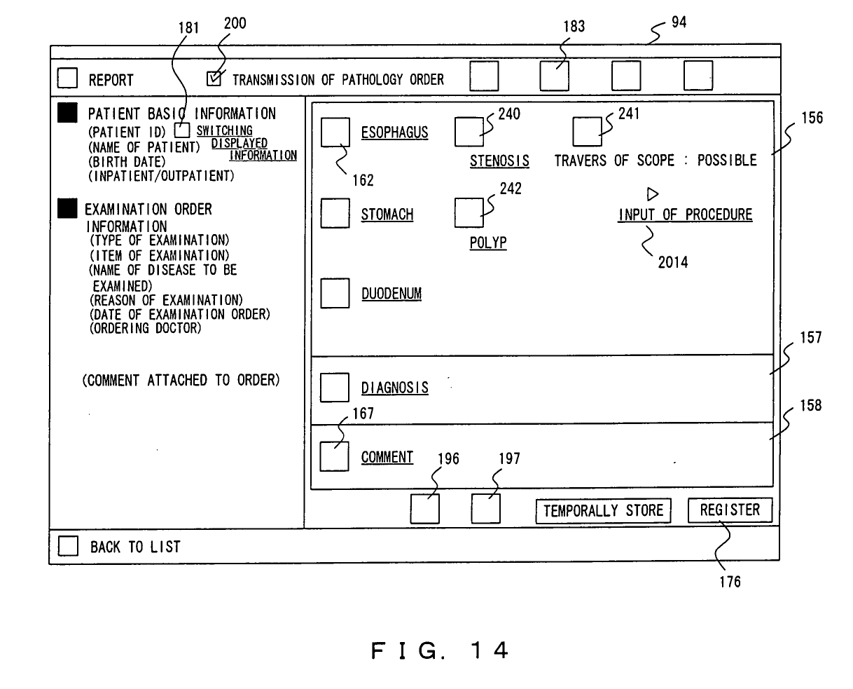

FIG. 14 shows a “Report inputting” window 94.

A report can be input by opening the above described “Report inputting” window 94 as shown in FIG. 14. On the “Report inputting” window 94, contents of the examination report (remarks and procedure 156, diagnosis 157, comment 158) can be registered on a right portion of the window in addition to that the patient information and the examination order information are displayed on a left portion of the window in the same manner as in the other respective windows.

(1) Remarks and Procedure

The selected terms of remarks and procedure can be registered on an implementation table, remarks term information table 160 and a procedure term information table 161 by obtaining the selection options from a term master file 159 in the database 21, displaying the selection options on the window, and by selecting the option.

(2) Diagnosis

The selected diagnosis term information can be registered on a diagnosis term information table 162 by obtaining the selection options from a term master file 159 in the database 21, displaying the selection options on the window, and by selecting the option.

The operations of the window displaying the remarks and procedure and the window displaying the contents of diagnosis as the selection options are common to each other.

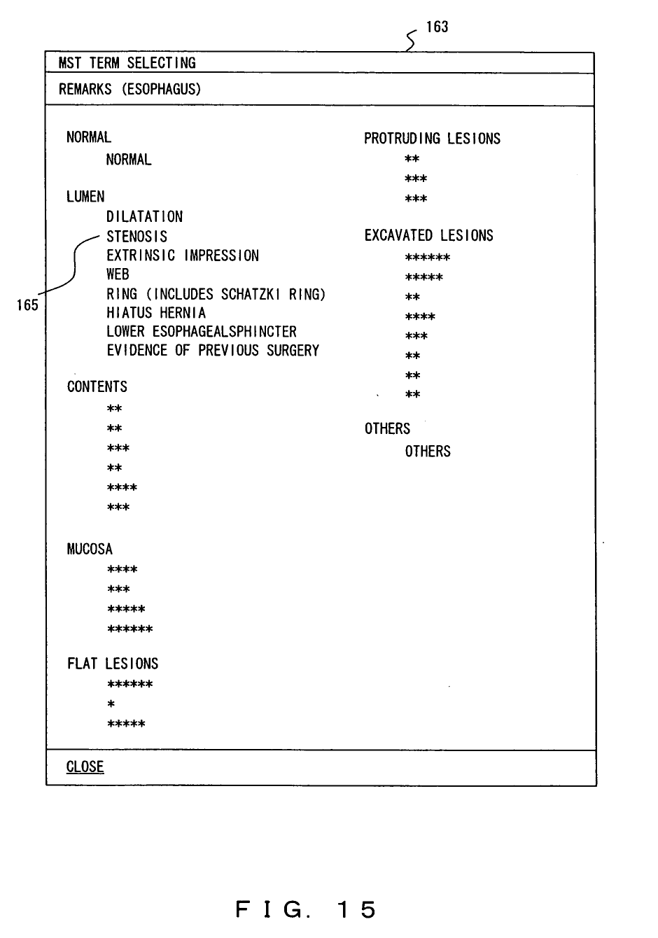

FIG. 15 shows an example of input of remarks.

A “Term” window 163 shown in FIG. 15 is a display example used for esophagus (The terms are used based on MST as Minimal Standard Terminology for endoscope) and is opened when an “Esophagus” button 162 on the “Report inputting” window 94 is pressed.

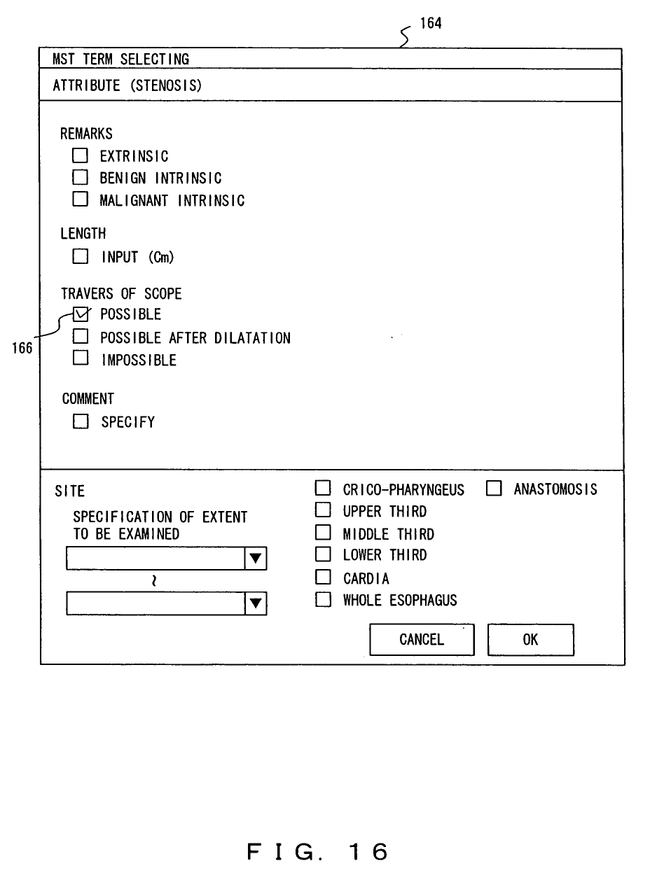

FIG. 16 shows a “Term” window 164.

The “Term” window 164 shown in FIG. 16 is a window which is opened when “Stenosis” 165 as one of terms to be selected on the window 163 is selected. For example, when the following contents of

(organ)—(group of terms)—(terms of remarks)—(title of attribute)—(attribute value)—esophagus-lumen stenosis-traverse of scope-Possible are to be input in accordance with the hierarchy of MST, the processes on the window are conducted as below.

Process 1: When the “Esophagus” button 162 is pressed, the window 163 is opened

Process 2: When “Stenosis” 165 is selected on the window 163, the window 164 is opened

Process 3: Check a checkbox “Possible” 166 into ON state of “Traverse of scope” on the window 164

Because two classes of the hierarchy are simultaneously displayed on one window as above, the selection can be completed by just three processes. This selection required five processes on a conventional system in which a tree is selected for inputting in accordance with the hierarchy.

Also, although the input may be conducted for each organ (site), a menu “Normal in every aspect” can be prepared for a case that every organ (site) is in a normal condition. In this case, “Normal” can be input as input about every organ (site) by one selection on a menu.

Next, an example of input about procedure will be explained.

When the above “Remarks” are input, the content of the input “Remarks” is displayed on the “Report inputting” window 94 (2013) and an “Input procedure” button 2014 is displayed. When the “Input procedure” button 2014 is pressed, the “Procedure inputting” window explained referring to FIG. 11 is opened. On the “Procedure selecting” window 2008, options 2010 for input of types of implemented procedure are displayed and by selecting the displayed options, the “Attribute inputting” window 2015 is opened for inputting the content of the selected option of the procedure.

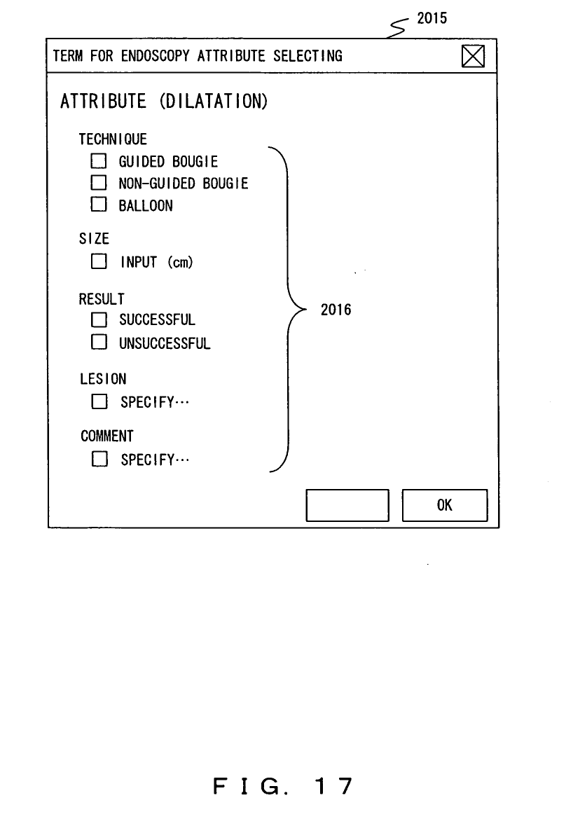

FIG. 17 shows the “Attribute inputting” window.

On the “Attribute inputting” window 2015, options 2016 are displayed so that contents of the procedure selected on the “Procedure inputting” window 2008 can be input. These options can be displayed by obtaining the terms registered in the term master file 159 in the database 21. By selecting the options 2016 on the window 2015, the contents of the procedure can be input. The input contents are registered on the procedure term information table 161 in the database 21.

The functions upon a press on the “Refer to past data” button 2007 explained regarding the “Photography” window 83 of FIG. 10 are realized by a configuration that the “Result” of successfulness/unsuccessfulness input on the “Attribute inputting” window 2015 is registered.

(3) Comment

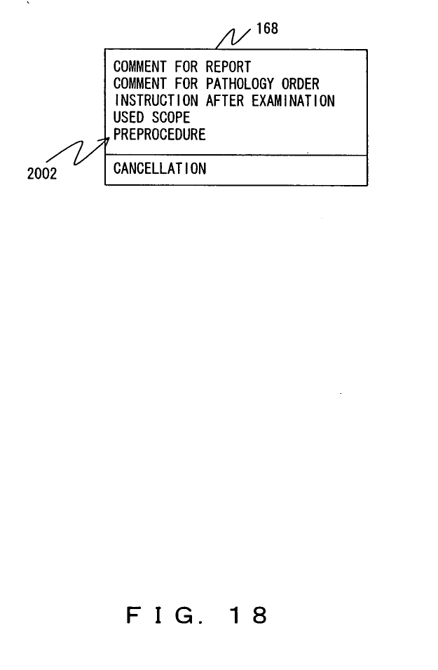

FIG. 18 shows a “Comment” menu 168.

When a “Comment” button 167 is pressed, the “Comment” menu 168 as shown in FIG. 18 is displayed for determining kinds of comments desired to be input and each comment can be input by selecting the options on the “Comment” menu 168 and opening a window for inputting text information. The input comment information is registered on a lesion table 168 in the database 21.

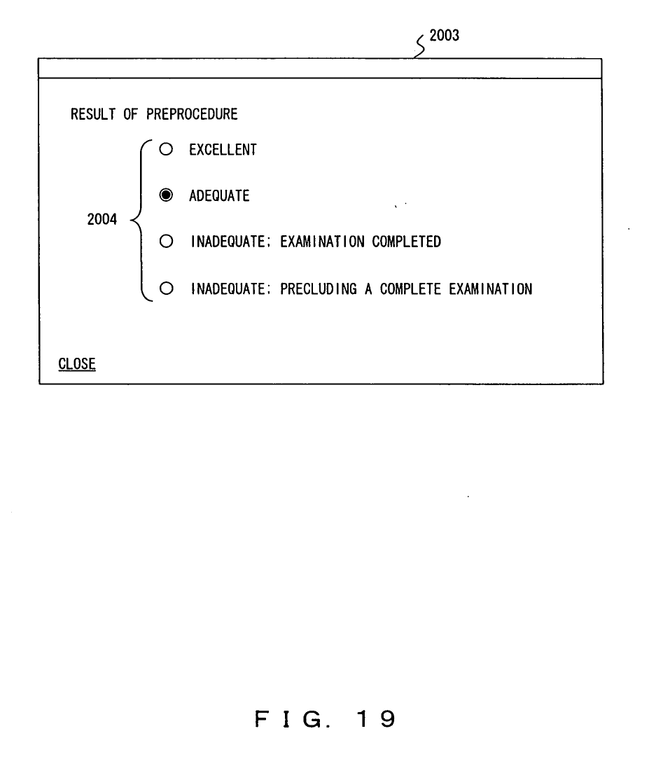

FIG. 19 shows an example in case that a “Preprocedure” 2002 is selected as an option on the “Comment” menu 168.

An “Option” window 2003 is opened for selecting and inputting the result of preprocedure and the options 2004 are prepared. By selecting and inputting the options 2004, the results (qualities) of the preprocedure can be recorded.

As for the results (qualities) of preprocedures, there are four results, i.e. (1) Excellent, (2) Adequate, (3) Inadequate; examination completed, (4) Inadequate; precluding a complete examination.

The result selected and input on the above window 2003 is registered on the lesion table 168 in the database 21.

When the input of the report information is completed as above, the registration of each of input report information can be completed by pressing a “Register” button 176 arranged on a right lower portion of the “Report inputting” window 94.

Further, the report once registered can not be overwritten so that each version is under the management by recording 1^{st} version, 2^{nd} version, 3^{rd} version and so on of the progress report and 1^{st} version, 2^{nd} version, 3^{rd} version and so on of the final report. (the history of reports are managed)

Each of pointer information associated with each report information on a report managing table 181 in the database 21 is managed so that the reports can be prepared utilizing the pointer information, and further, the above described report status and the versions are managed on the above report managing table 181 making it possible that the history of report can be managed without overwriting the reports.

<Step 8 (S8)>

As above, the transmitted report information can be referred to in a system of endoscope department and also, is transmitted to the HIS via LAN by the GW 1 so that the report information can be referred to in an electronic medical record system of the HIS.

Further, upon the registration and the transmission of a report, a pathology order can be issued based on the report information (Step 10 (S10)). When the pathology order is issued, the information of the pathology order is registered on a pathology order managing table 198 in the database 21 and an image attached to the pathology order is registered on the pathology image table 199. Further, an icon 197 indicating that a pathology order has been issued is displayed on a lower portion of the “Report” window 94.

Also, it is not uniquely determined whether or not the pathology order has to be transmitted again in case that the version of a report is updated when the report is registered and transmitted again.

Therefore, a checkbox 200 determining whether or not the pathology order is transmitted upon the update of report is arranged on the upper portion of the “Report inputting” window so that the pathology order is issued upon the update of report only when the above checkbox 200 is checked into ON state.

A second embodiment is substantially the same with the first embodiment. Accordingly, only the different points are explained and the like components are denoted by the like numerals so that the explanation thereof is omitted.

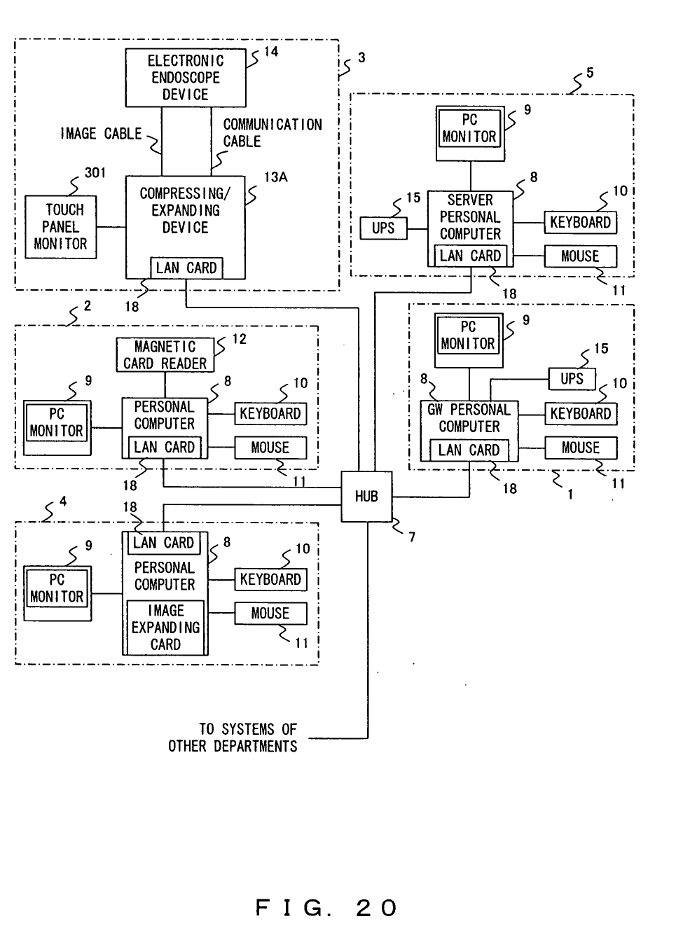

FIG. 20 shows a hardware configuration of an endoscope examination management system according to the second embodiment.

The points different from the first embodiment are explained. In the present embodiment, a compressing/expanding device 13A shown in FIG. 20 is provided with a function as a personal computer and a touch panel 301 having a display unit for displaying a GUI screen is connected to the compressing/expanding device 13A. The touch panel 301 is installed near an examination bed, being different from the PC monitor 9 in the first embodiment.

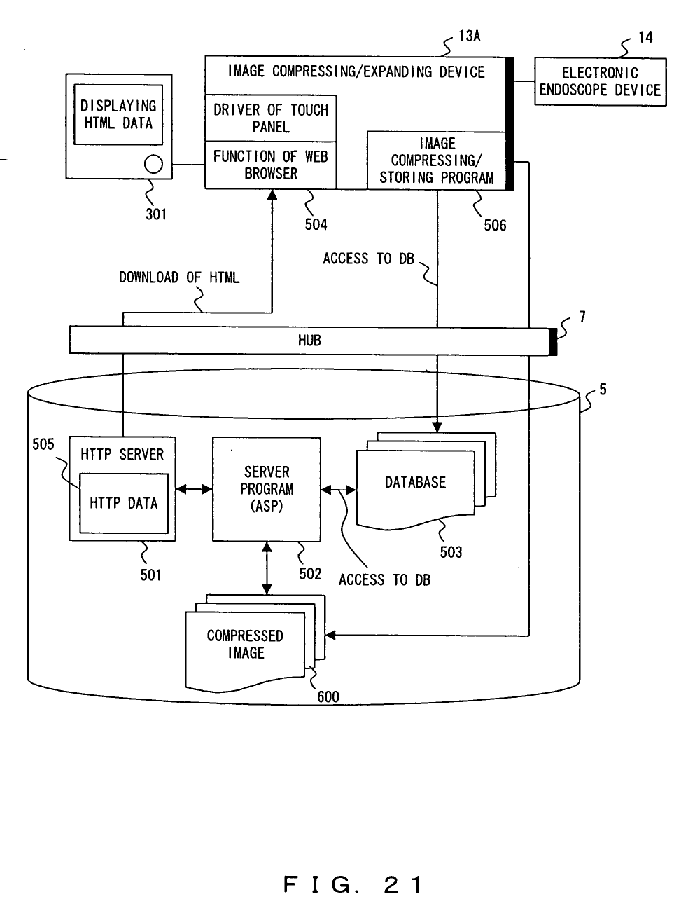

FIG. 21 shows a software configuration of the endoscope examination management system.

In the server 5, a HTTP server 501, a server program 502 and a database 503 are installed in order to be operated thereon.

The compressing/expanding device 13A includes a Web browsing function 504 in order to download HTML data 505 from a HTTP server 501 via the HUB 7. In the server 5, the server program 502 is activated and the HTML data 505 is generated in the HTTP server 501. Thereby, the HTML data 505 can be displayed on the touch panel 301 connected to the image compressing device 13A.

As for image data transmitted from the electronic endoscope device 14, an image compressing/storing program 506 accesses to a database 503 in the server 5 in order to store the image data in the server 5 as a compressed image 600.

In the second embodiment, functions of the photography window, the implementation information inputting window and the report information inputting window which were explained in the first embodiment are realized and respective windows are displayed on the touch panel 301 so that input and reference of data can be conducted thereon.

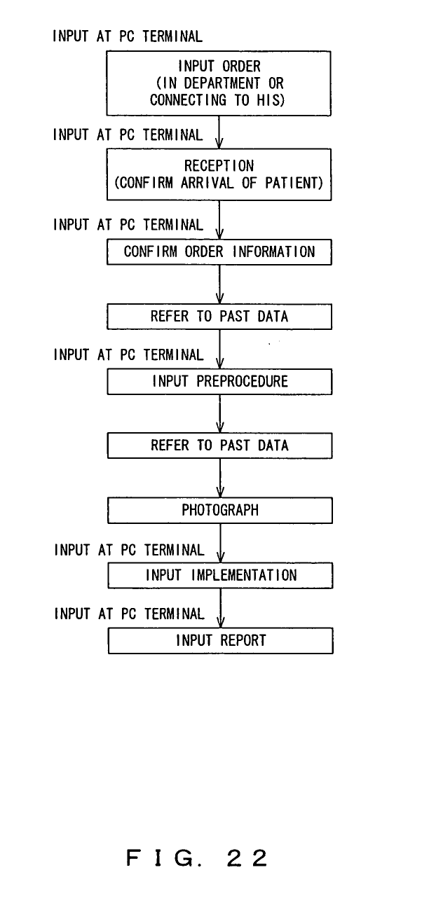

FIG. 22 explains an input transaction of the first embodiment.

In the first embodiment, all transactions of input of order, implementation, and report are conducted using the personal computer terminal.

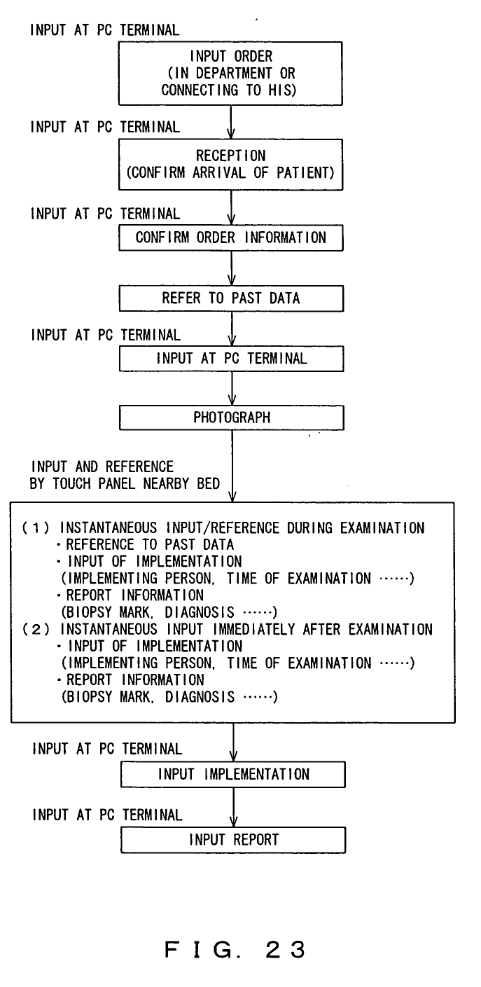

FIG. 23 explains an input transaction of the second embodiment.

The different point from the first embodiment is that by using the touch panel 301 installed nearby the examination bed, the reference to the photography window, the input of the implementation information and the input of the report information can be instantaneously conducted during the examination. And also, the input of the implementation and the report information can be conducted even immediately after the examination. Also, in comparison with the first embodiment of FIG. 22, in the second embodiment, the implementation information can be input during and immediately after the examination so that the operations are simplified and the miss in inputting data can be avoided in case that the input is conducted on a PC terminal after the examination. Accordingly, a more precise input of the implementation information can be realized.

As explained above, in the second embodiment, by arranging the touch panel 301 nearby the examination bed, the reference to the photography window, the input of the implementation information and the input of the report information can be more precisely and more smoothly conducted during and immediately after the examination. Further, because operations on a keyboard or a mouse of a personal computer in an examination room are not needed, the space can be saved.

The present invention has been explained hereinbefore with reference to the drawings, however, it is noted that the invention is not limited to the above explained embodiments and various modifications and various alternations can be made within a scope of the invention and without departing from the spirit of the invention.

1. An examination management system, comprising:
an implemented information inputting unit for inputting implemented information related to a content of implementation of medical conduct which conduct is implemented regarding the examination;
an implemented information storing unit for storing therein the implemented information input by the implemented information inputting unit;
an implemented information obtaining unit for obtaining, from the implemented information storing unit, implemented information corresponding to a content of implementation which is scheduled to be implemented using as a key a content of implementation of medical conduct which is scheduled to be currently implemented; and
an implemented information displaying unit for displaying the implemented information obtained by the implemented information obtaining unit.

2. An examination management system, comprising:
an implemented information inputting unit for inputting implemented information related to a content of implementation of medical conduct which conduct is implemented regarding the examination;
an implemented information storing unit for storing therein the implemented information input by the implemented information inputting unit;
an implemented information obtaining unit for obtaining, from the implemented information storing unit, implemented information corresponding to a content of implementation which is scheduled to be implemented using as a key a content of implementation of medical conduct which is scheduled to be currently implemented;
a calculating unit for calculating implemented information processed information by conducting prescribed processing on the implemented information obtained by the implemented information obtaining unit; and
a processed information displaying unit for displaying the implemented information processed information calculated by the calculating unit.

3. An examination management system, comprising:
an implemented information inputting unit for inputting implemented information related to a content of implementation of medical conduct which conduct is implemented regarding the examination;
an implemented information storing unit for storing therein the implemented information input by the implemented information inputting unit;
an implemented information obtaining unit for obtaining, from the implemented information storing unit, implemented information corresponding to a content of implementation which is scheduled to be implemented using as a key a content of implementation of medical conduct which is scheduled to be currently implemented;
an implementation status calculating unit for calculating implementation status information indicating an implementation status of implementation information corresponding to a content of implementation which is scheduled to be implemented by conducting prescribed statistical processing, as calculation processing, on a plurality of the implemented information obtained by the implemented information obtaining unit;
an implementation status information displaying unit for displaying the implementation status information calculated by the implementation status calculating unit.

4. The examination management system according to claim 1, wherein
the implemented information displaying unit displays implemented information before or during an input operation of the implemented information by the implemented information inputting unit.

5. The examination management system according to claim 2, wherein
the processed information displaying unit displays the implemented information processed information before or during an input operation of the implemented information by the implemented information inputting unit.

6. The examination management system according to claim 3, wherein
the implementation status information displaying unit displays the implementation status information before or during an input operation of the implemented information by the implemented information inputting unit.

7. An examination management method, comprising:
a step of inputting implemented information related to a content of implementation of medical conduct in which the conduct is implemented regarding the examination;
a step of storing the input implemented information in an implemented information database;
a step of obtaining, from the implemented information database, implemented information corresponding to a content of implementation which is scheduled to be implemented using as a key a content of implementation of medical conduct which is scheduled to be currently implemented; and
a step of displaying the obtained implemented information.

8. An examination management method, comprising:
a step of inputting implemented information related to a content of implementation of medical conduct which conduct is implemented regarding the examination;
a step of storing the input implemented information in an implemented information database;
a step of obtaining, from the implemented information database, implemented information corresponding to a content of implementation which is scheduled to be implemented using as a key a content of implementation of medical conduct which is scheduled to be currently implemented;
a step of calculating implemented information processed information by conducting prescribed calculating processing on the obtained implemented information; and
a step of displaying the implemented information processed information which is calculated.

9. An examination management method, comprising:
a step of inputting implemented information related to a content of implementation of medical conduct which conduct is implemented regarding the examination;
a step of storing the input implemented information in an implemented information database;
a step of obtaining, from the implemented information database, implemented information corresponding to a content of implementation which is scheduled to be implemented using as a key a content of implementation of medical conduct which is scheduled to be currently implemented;
a step of calculating implementation status information indicating an implementation status of implemented information corresponding to a content of implementation which is scheduled to be implemented by conducting prescribed statistical processing, as calculation processing, on the obtained plurality of the implemented information; and
a step of displaying the calculated implementation status information.

10. The examination management method according to claim 7, wherein
implemented information is displayed after a storage operation of the implemented information in the implemented information database and before or during an input operation of other implemented information.

11. The examination management method according to claim 8, wherein
implemented information processed information is displayed after a storage operation of the implemented information in the implemented information database and before or during an input operation of other implemented information.

12. The examination management method according to claim 9, wherein
implementation status information is displayed after a storage operation of the implemented information in the implemented information database and before or during an input operation of other implemented information.

13. An examination management system, comprising:
implemented information inputting means for inputting implemented information related to a content of implementation of medical conduct in which the conduct is implemented regarding the examination;
implemented information storing means for storing therein the implemented information input by the implemented information inputting means;
implemented information obtaining means for obtaining, from the implemented information storing means, implemented information corresponding to a content of implementation which is scheduled to be implemented using as a key a content of implementation of medical conduct which is scheduled to be currently implemented; and
implemented information displaying means for displaying the implemented information obtained by the implemented information obtaining means.
